(19) United States
(12) Patent Application Publication
(10) Pub. No.: US 2007/0195366 A1
(43) Pub. Date: Aug. 23, 2007

(54) Printing apparatus and method for saving memory

(75) Inventor: Ji-yeon Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon (KR)

(21) Appl. No.: 11/653,969

(22) Filed: Jan. 17, 2007

(30) Foreign Application Priority Data
Feb. 23, 2006 (KR) 2006-17764

(51) Int. Cl. G06K 15/00

(52) U.S. Cl. 358/1.16

(57) ABSTRACT

A printing apparatus and a method for saving memory space, which reduces memory space required for content to be printed. The printing apparatus includes a content storage unit to store content to be printed, a used object counting unit to analyze the content and to count a number of the used objects included in the content based on a result of the analysis, a printed page counting unit to count the number of printed pages including the objects during the printing of the content, and a control unit to judge whether to delete the objects according to the number of printed pages.

### CROSS-REFERENCE TO RELATED APPLICATIONS

This application claims the benefit of Korean Application No. 2006-17764, filed Feb. 23, 2006, in the Korean Intellectual Property Office, the disclosure of which is incorporated herein by reference.

### BACKGROUND OF THE INVENTION

1. Field of the Invention

Aspects of the present invention relate to a printing apparatus and a method of saving memory space, and, more particularly, to a printing apparatus and a method that reduces memory space required for content to be printed.

2. Description of the Related Art

Generally, a printing device that is capable of printing content, such as a printer and a facsimile, loads content stored in a storage medium, such as a floppy diskette or a CD, into a memory. The printing device may also load content that is transmitted through a network to which the printing device is connected to the memory. The printing device then prints the corresponding content. The content loaded in the memory may be images, fonts and style sheets. These are continuously stored in the memory until the printing of the corresponding content is completed. Then, when the printing of the content is completed, the content and the images, fonts and style sheets are deleted.

FIG. 1 is a block diagram illustrating the construction of a conventional printing device. As shown in FIG. 1, the conventional printing device 10 includes a content storage unit 11, a content analysis unit 12, a layout setting unit 13, a printing unit, and a control unit 15. The content storage unit 11 may be a memory to store the content to be printed, the stored content including images, fonts, and style sheets. The content analysis unit 12 analyzes the images, fonts, and style sheets being used when the layout setting unit 13 sets the layout of the content, and issues a request of the images, fonts, and style sheets to be used to an external device through a network, such as the Internet, if the images, fonts, and style sheets being used are not included in the content stored in the content storage unit 11. The printing unit 14 prints the content stored in the content storage unit 11 by positioning the images, fonts, and style sheets analyzed by the content analysis unit 12 in the layout set by the layout setting unit 13. The control unit 15 judges whether the printing of the content stored in the content storage unit 11 is completed, and, if the printing is completed, the control unit 15 deletes the content stored to secure memory space.

The printing device 10 generally prints the content stored in the content storage unit 11 in units of pages, and unlike a display device displaying the content, the printing device 10 moves printed pages according to user commands so that those pages are not reprinted.

In other words, with respect to the content display device, even the content that has already been displayed once may be displayed again through a scroll operation of a user. Thus, accurately predicting the time point where the object is not used any more is difficult. Accordingly, the object should be continuously stored. By contrast, with respect to the printing device 10, there is insufficient storage space to allow for the reuse of the objects included in pages that have been printed already.

However, the conventional printing device 10 of FIG. 1 continuously stores all the content that has already been printed until the printing of the content stored in the content storage unit 11 is completed. Thus, the use of the memory is increased to cause a drop off in memory efficiency. Further, where the printing device 10 is low-grade, the continuous storage of all the objects until the printing of the content is completed may cause the printing speed of the printing device 10 to deteriorate.

Japanese Patent Unexamined Publication No. 2005-115542 discloses a document information output system that outputs structured document information in units of pages without carrying a processing load. However, in this output system, since the objects included in the content loaded in a memory of a printing device are maintained until the printing of the loaded content is completed, securing a sufficient memory space is difficult.

### SUMMARY OF THE INVENTION

Accordingly, aspects of the present invention solve the above-mentioned and/or other problems occurring in the related art, and an aspect of the present invention provides a printing apparatus and a method of saving memory space, which secures a memory space by counting the number of printed objects included in content and deletes the corresponding objects if they are no longer used.

According to an aspect of the present invention, there is provided a printing apparatus to save memory, the apparatus comprising: a content storage unit to store content to be printed; a used object counting unit to analyze the content and to count a number of the used objects included in the content based on a result of the analysis; a printed page counting unit to count the number of printed pages including the objects during the printing of the content; and a control unit to judge whether to delete the objects according to the number of printed pages.

According to another aspect of the present invention, there is provided a printing method to save memory space, the method comprising: storing content to be printed; analyzing the content to identify used objects therein; counting a number of used objects included in the content; counting a number of printed pages including the objects during the printing of the content; and judging whether to delete the objects according to the number of printed pages.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating the construction of a conventional printing device;

FIG. 2 is a block diagram illustrating the construction of a printing apparatus for saving memory space according to an embodiment of the present invention;

FIG. 3 is a view illustrating the construction of a used object counting unit according to an embodiment of the present invention;

FIG. 4 is a flowchart illustrating a method of counting a first number and a second number according to an embodiment of the present invention;

FIG. 5 is a flowchart illustrating a method of counting a third number according to an embodiment of the present invention;

FIG. 6 is a view illustrating a layout according to an embodiment of the present invention;

FIG. 7 is a view illustrating a layout of which the printing is under way according to an embodiment of the present invention; and

FIG. 8 is a view illustrating a layout of which the printing is completed according to an embodiment of the present invention.

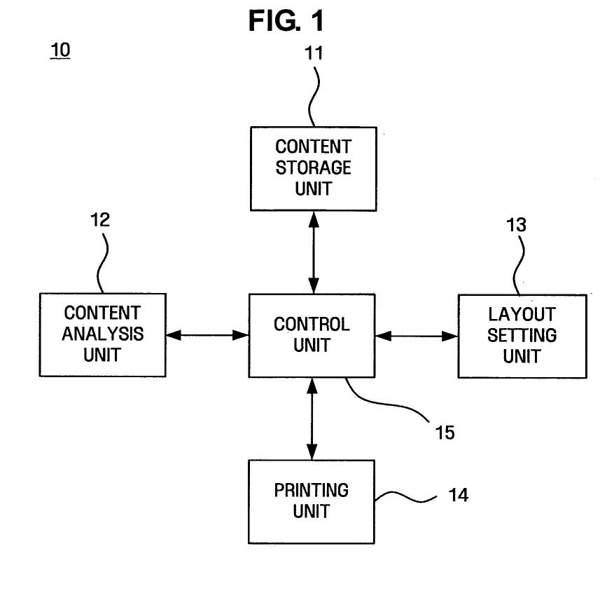

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention will be described herein with reference to the accompanying drawings illustrating block diagrams and flowcharts to explain a printing apparatus and a method of saving memory space according to embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations to implement the functions specified in the flowchart block or blocks.

Also, each block of the flowchart illustrations may represent a module, segment, or portion of code, which comprises one or more executable instructions to implement the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

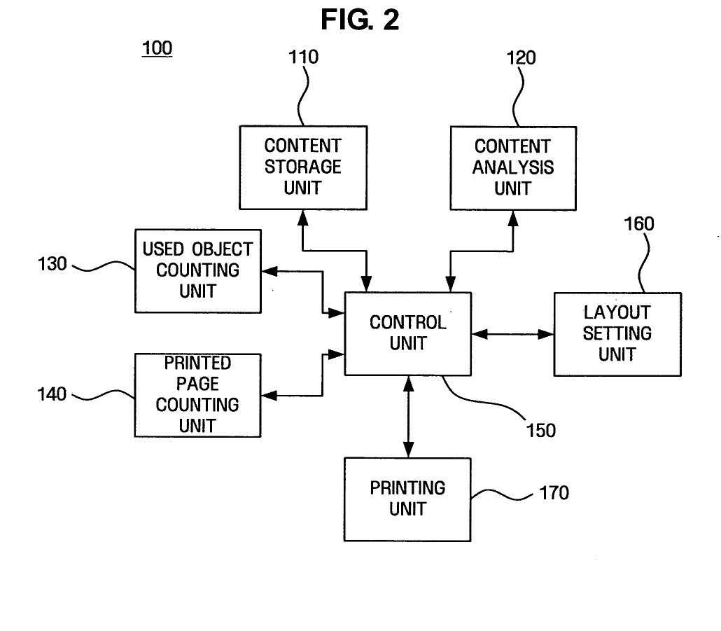

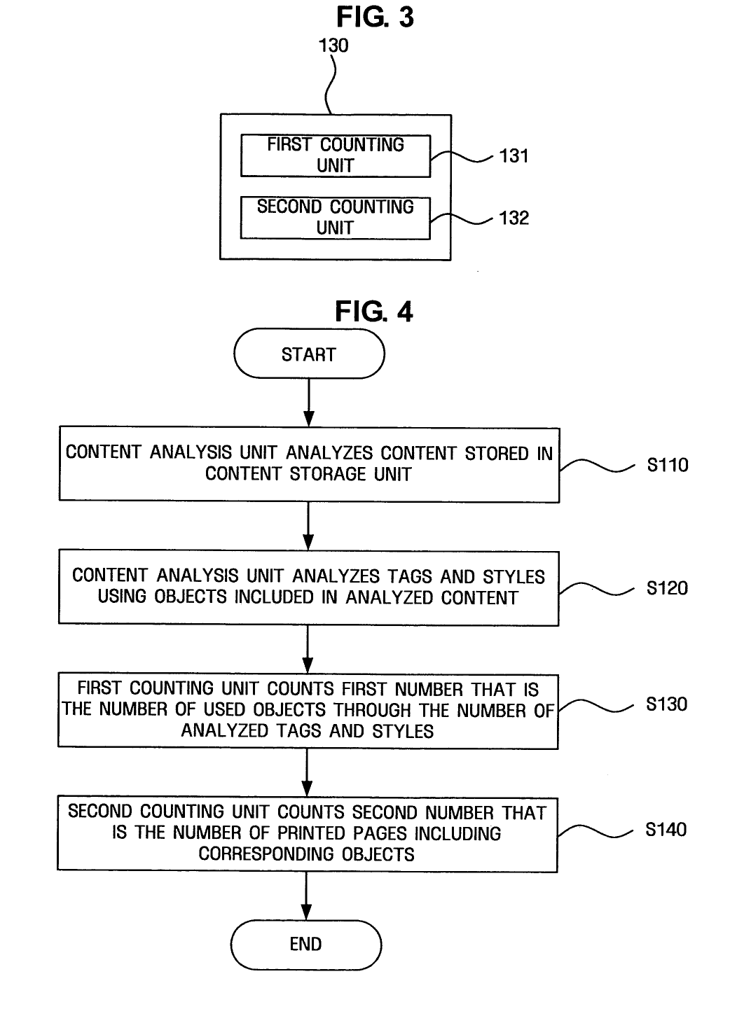

FIG. 2 is a block diagram illustrating the construction of a printing apparatus to save memory space according to an embodiment of the present invention. As shown in FIG. 2, the printing apparatus 100 includes a content storage unit 110, a content analysis unit 120, a used object counting unit 130, a printed page counting unit 140, a control unit 150, a layout setting unit 160, and a printing unit 170. The content storage unit 110 stores content to be printed through the print apparatus 100. The content may comprise a markup language, such as a Hyper Text Markup Language (HTML), extensible Markup Language (XML), and extensible HTML (XHTML), but is not limited thereto. Also, the content storage unit 110 may store all the content to be printed. Alternately, the content storage unit 110 may successively store only content of a specified size according to a printing order. In other words, a part of the content that is first stored in the content storage unit 110 is deleted after the completion of the printing, and then another part of the content is stored in the content storage unit 110.

The content storage unit 110 may be understood as a memory that loads the content to be printed by the printing apparatus 100. The content storage unit 110 may include devices in the form of a cache, read only memory (ROM), programmable read only memory (PROM), erasable programmable read only memory (EPROM), electronically erasable programmable read only memory (EEPROM), flash, static random access memory (SRAM), and dynamic random access memory (DRAM), as well as other similar types of memory. According to embodiments of the present invention, the content may include objects such as images, fonts, and style sheets as well as other similar objects.

The content analysis unit 120 analyzes the content stored in the content storage unit 110, and analyzes tags and styles that use the specified objects included in the analyzed content. The number of analyzed tags and styles are used for the used object counting unit 120 to be explained later to count the number of used objects. In addition, if the specified objects included in the analyzed content are stored in the external device, the content analysis unit 120 may request the corresponding objects to the external device based on object information that includes object names and storage paths of the corresponding objects included in the analyzed content. In this case, the objects requested by the content analysis unit 120 are transmitted from the external device and stored in the content storage unit 110.

The used object counting unit 130 counts the number of used objects where the content analysis unit 120 prints the content through an analysis of the content stored in the content storage unit 110. In this case, the used object counting unit 130 includes a first counting unit 131 that counts a first number (i.e., a number of tags and styles that use the specified objects through a result of the analysis performed by the content analysis unit 120) and a second count unit 132 that counts a second number (i.e., a number of pages including the specified objects according to a layout set by the layout setting unit 160 to be explained later).

According to an embodiment of the present invention, the first number counted by the first counter 131 refers to the number of elements such as tags and styles that use the specified objects during the content analysis. In this case, the tags include source (src) attributes of an image tag and an object tag in the content, and the styles include a background image and a list-style-image in the content that uses a Cascading Style Sheet (CSS).

Specifically, the content stored in the content storage unit 110 is analyzed by the content analysis unit 120. The content analysis unit 120 analyzes the number of tags and styles that use the specified objects during the content analysis process. In this case, the first counting unit 131 counts the first number used by the specified objects in the content analysis process performed by the content analysis unit 120.

The second counting unit 132 counts the number of pages on which the specified objects are printed when the layout setting unit 160 sets the layout. In other words, the first number counted by the first counting unit 131 is obtained by counting the number of used objects without consideration of a number of pages the specified objects are printed on, and the second counting unit 132 counts the number of pages on which the specified objects are printed. According to embodiments of the present invention, the counting of the first number through the first counting unit 131 and the counting of the second number through the second counting unit 132 may be performed together or separately. For example, if it is assumed that the first number that is counted by the first counting unit 131 is “1” and the number of pages to be printed is “3” where the counting of the first number and the counting of the second number are performed together, the second counting unit 132 applies “3,” which is the number of pages being printed, to “1,” which is the first number. Accordingly, the second number becomes “4” which is obtained by adding “3” to “1,” and then “3” is counted as the final second number by subtracting “1” from “4”.

When the content stored in the content storage unit 110 is printed through the printing unit 170, the printed page counting unit 140 counts a third number that represents the number of pages including the specified objects included in the corresponding content. In this case, the third number is obtained by decreasing the second number counted by the second counting unit 132 whenever one page is printed, and it may be understood that when the third number finally becomes “0”, the printing of all the pages including the specified objects is completed. In other words, it may be understood that the third number is the number obtained by subtracting the number of pages presently printed from the second number.

The control unit 150 determines whether to delete the objects included in the content stored in the content storage unit 110 by judging whether the third number counted by the printed page counting unit 140 is “0.” In other words, unlike the case of a content display device where there is no room for the reuse of the content once printed during the printing of a page including the specified objects, the control unit 150 deletes the content stored in the content storage unit 110 just after the use of the specified objects is completed to secure the memory space. Specifically, although there is room for a re-display of the content once displayed through a display device, there is no room for the reuse of the content once printed through the printing apparatus. Thus, the once printed content may be deleted.

The layout setting unit 160 sets a layout in which the content is to be printed. The second counting unit 132 counts the second number in accordance with the set layout. The layout may include tags and styles that use the specified objects. The printing unit 170 prints the content stored in the content storage unit 110 according to the layout set by the layout setting unit 160. According to an embodiment of the present invention, the printed page counting unit 140 counts the third number and the control unit 150 deletes the corresponding objects from the content storage unit 110 when the third number becomes “0” to secure storage space in the content storage unit 110.

FIG. 4 is a flowchart illustrating a method of counting the first number and the second number according to an embodiment of the present invention. As is illustrated in FIG. 4, the content analysis unit 120 analyzes the content stored in the content storage unit 110 S110, and then analyzes tags and styles that use the specified objects included in the analyzed content S120. The first counting unit 131 counts the first number S130. The second counting unit 132 counts the second number S140 at the same time as the counting of the first number or separately from the counting of the first number.

In FIG. 4, the content stored in the content storage unit 110 includes the specified contents. However, where the corresponding objects are stored in the external device, the content analysis unit 120 requests the corresponding objects to the external device. Specifically, where the objects are stored in the external device, the content stored in the content storage unit 110 includes object information including the object names and storage paths of the corresponding objects, and the content analysis unit 120 requests the corresponding objects to the external device through the object information included in the analyzed content.

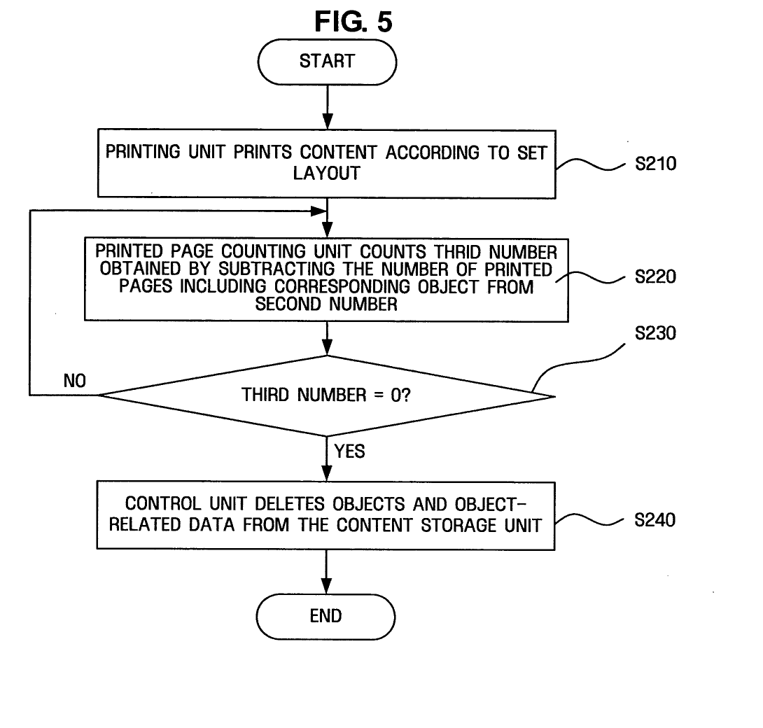

FIG. 5 is a flowchart illustrating a method of counting the third number according to an embodiment of the present invention. As is illustrated in FIG. 5, the printing unit 170 prints the content stored in the content storage unit 110 according to the layout set by the layout setting unit 160 S210. In this case, the layout setting unit 160 positions the specified objects in the set layout, and the printing unit 170 prints the layout in which the corresponding objects are located. The printed page counting unit 140 counts the third number, which is obtained by subtracting the number of printed pages including the specified objects from the second number, while the printing unit 170 prints the content S220. The control unit 150 judges whether the third number counted by the printed page counting unit 140 is “0” S230, and, if the third number is found to be “0,” the control unit 150 deletes the objects and object-related data from the content storage unit 110 S240.

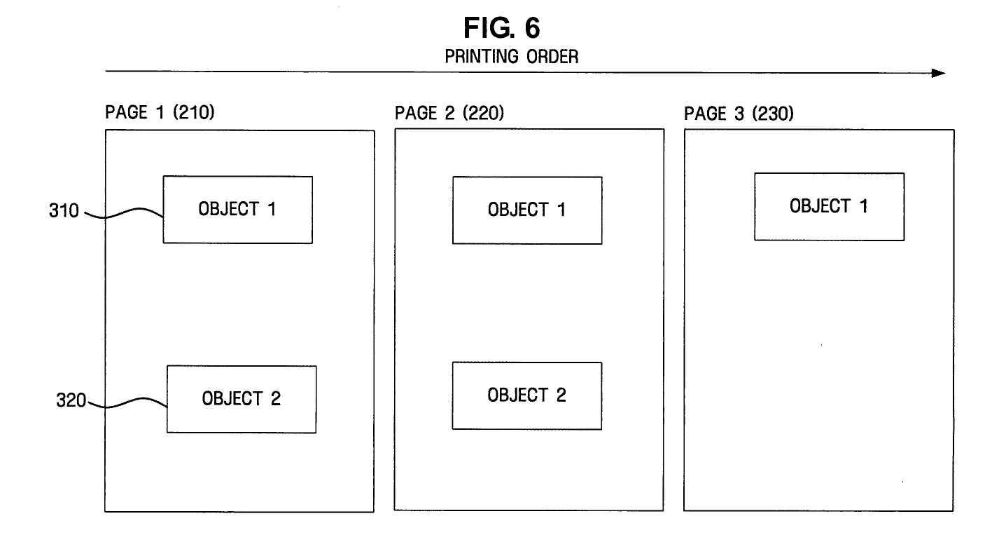

FIG. 6 is a view illustrating the layout set by the layout setting unit according to an embodiment of the present invention. In FIG. 6, object 1 and object 2 exist and are included in pages 1, 2 and 3. As illustrated in FIG. 6, the layout includes page 1 210, page 2 220, and page 3 230. It can be seen in FIG. 6 that the first number for object 1 310 is “3,” and the first number for object 2 320 is “2.” Also, the second number for object 310 is “3,” and the second number for object 2 320 is “2.”

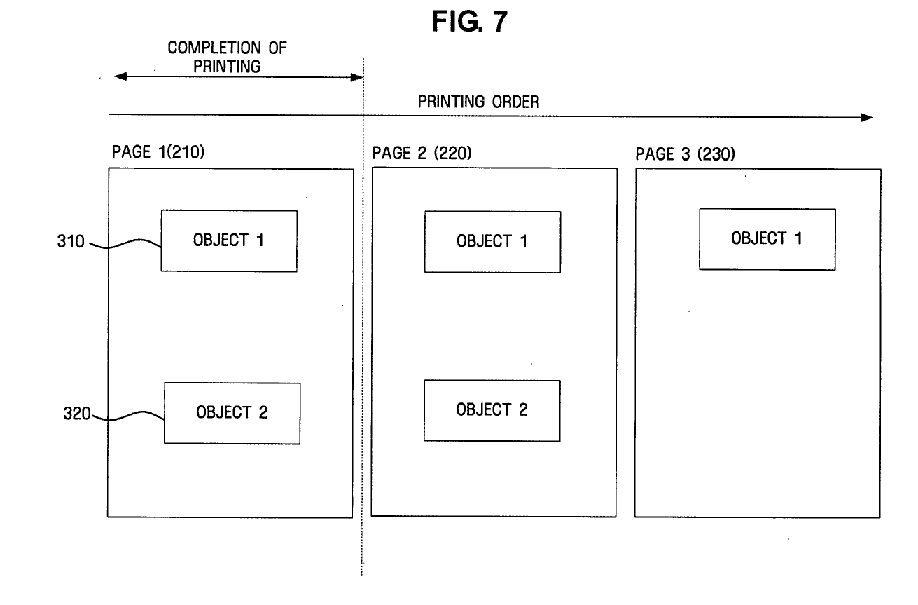

FIG. 7 is a view illustrating the layout of which the printing is under way according to an embodiment of the present invention. As is illustrated in FIG. 7, if the printing of page 1 210 is completed, the printed page counting unit 140 counts the third numbers for object 1 310 and object 2 320. As described above, it may be understood that the third number is the number obtained by subtracting the number of pages presently printed from the second number. When the printing of page 1 210 is completed, the third number for object 1 310 becomes “2,” and the third number for object 2 320 becomes “1.”

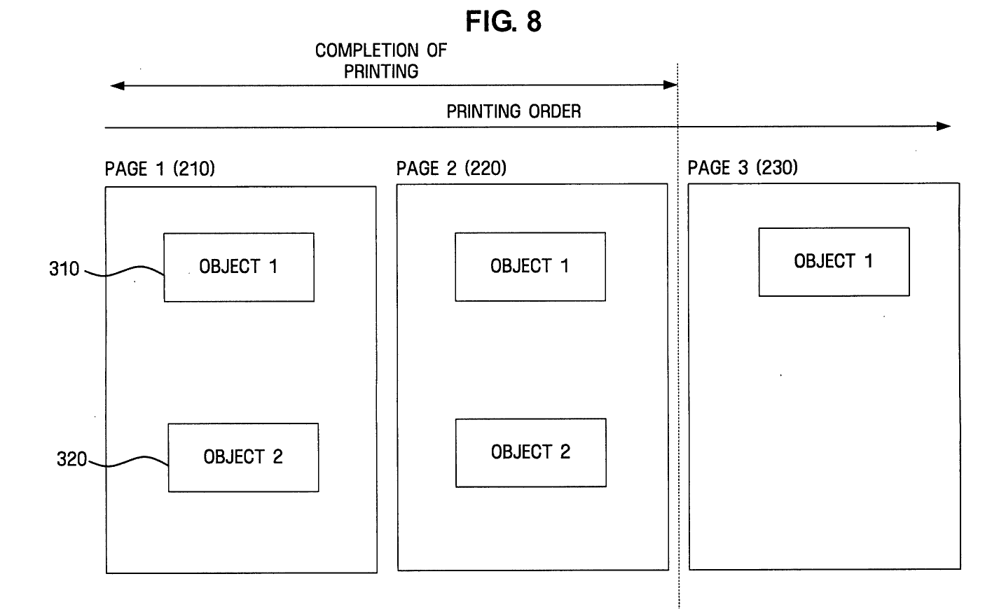

FIG. 8 is a view illustrating the layout of which the printing is completed according to an embodiment of the present invention. In FIG. 8, it is exemplified that the printing of object 2 310 between object 1 310 and object 2 320 of FIG. 6 is completed. When the printing of page 1 210 and page 2 220 is completed, the printed page counting unit 140 counts the third numbers for object 1 310 and object 2 320 in the same manner in FIG. 7. Specifically, the third number for object 1 310 becomes “1,” and the third number for object 2 320 becomes “0. If the third number of object 2 320 becomes “0,” the corresponding object will be not used any more.

Accordingly, the control unit 150 deletes object 2 320 from the content storage unit 110 to secure much more storage space. On the other hand, even when the printing up to page 3 230 is completed, although not illustrated in FIG. 8, the control unit 150 counts the third number for object 1 310 in the same manner as in FIG. 8, and, if the printing of page 2 230 is completed, the third number for object 1 310 also becomes “0.” Accordingly, if the printing of the page 3 230 is completed, the control unit 150 deletes object 1 310 from the content storage unit 110.

If the printing is completed through the counting of the number of printed pages including the specified objects, the corresponding object is deleted. Thus, much more storage space may be secured in the content storage unit 110. In addition, even when the divided content of a specified size are successively stored, a part of the previously stored content is deleted after the completion of the printing of the corresponding part. Thus, the storage space for another part of the content to be stored next can be secured.

In the embodiments of the present invention, the term “unit,” as used herein, refers to, but is not limited to, a software or hardware component, such as a Field Programmable Gate Array (FPGA) or Application Specific Integrated Circuit (ASIC), which performs certain tasks. A unit may be configured to reside on the addressable storage medium and to be executed on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

As is described above, according to aspects of the printing apparatus and a method of saving memory space according to the present invention, whether the printing of a page including specified objects included in the content is completed when a specified content is printed is judged, and, if the printing is completed, the corresponding objects are deleted to secure much more memory space.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A printing apparatus to save memory, the apparatus comprising:
a content storage unit to store content to be printed;
a used object counting unit to analyze the content and to count a number of the used objects included in the content based on a result of the analysis;
a printed page counting unit to count the number of printed pages including the objects during the printing of the content; and
a control unit to judge whether to delete the objects according to the number of printed pages.

2. The printing apparatus according to claim 1, wherein the content is composed of a language including content to be shared by a plurality of pages to be printed.

3. The printing apparatus according to claim 1, wherein, when the content is prepared by a markup language, the objects comprise at least one of an image, a font, and a style sheet.

4. The printing apparatus according to claim 1, wherein the used object counting unit comprises:
a first counting unit to count a first number equal to the number of used objects in the content; and
a second counting unit to count a second number that is the number of printed pages.

5. The printing apparatus according to claim 1, further comprising:
a content analysis unit to analyze a relationship between the objects and the content;
a layout setting unit to set a layout of the page during the printing of the content in accordance with the relationship between the objects and the content; and
a printing unit to print the content by applying the objects to the layout.

6. The printing apparatus according to claim 5, wherein the content comprises object information including at least one of object names and/or storage paths of the objects.

7. The printing apparatus according to claim 6, wherein the content analysis unit sends requests for the objects to the external device if the objects are not included in the content.

8. The printing apparatus according to claim 4, wherein the printed page counting unit counts a third number that is obtained by subtracting the number of printed pages from the second number, and wherein the control unit deletes the objects from the content storage unit when the third number is found to be “0”.

9. A printing method to save memory space, the method comprising:
storing content to be printed;
analyzing the content to identify used objects therein;
counting a number of used objects included in the content;
counting a number of printed pages including the objects during the printing of the content; and
judging whether to delete the objects according to the number of printed pages.

10. The printing method according to claim 9, wherein the content is composed of a language including content that is to be shared by a plurality of pages to be printed.

11. The printing method according to claim 9, wherein, when the content is prepared by a markup language, the objects comprise at least one of an image, a font, and a style sheet.

12. The printing method according to claim 9, wherein the counting of the number of used objects comprises:
counting a first number that is equal to the number of used objects in the content; and
counting a second number that is equal to the number of printed pages.

13. The printing method according to claim 9, further comprising:
analyzing a relationship between the objects and the content;
setting a layout of the page during the printing of the content in accordance with the relationship; and
printing the content by applying the objects to the layout.

14. The printing method according to claim 13, wherein the content comprises object information including at least one of object names and storage paths of the objects.

15. The printing method according to claim 14, wherein the analyzing comprises sending requests for the objects to the external device if the objects are not included in the content.

16. The printing method according to claim 12, wherein the counting of the number of printed pages comprises:
counting a third number that is obtained by subtracting the number of printed pages from the second number; and
deleting the objects when the third number is found to be “0”.

17. A printing apparatus, comprising:
a content storage unit to store content to be printed on printed pages;
a counting unit to identify various objects within the content and to determine which of the printed pages include each of the various objects; and
a control unit to delete each of the various objects once a last one of the printed pages on which each of the various objects respectively appears.

18. The printing apparatus according to claim 17, wherein, when the content is prepared by a markup language, the objects comprise at least one of an image, a font, and a style sheet.

19. A method of operating a printing apparatus, comprising:
storing content to be printed on printed pages;
identifying various objects within the content;
determining which of the printed pages include each of the various objects; and
deleting each of the various objects once a last one of the printed pages on which each of the various objects respectively appears.

20. A computer readable medium having a program stored thereon to execute the method according to claim 19.
